(19) United States
(12) Patent Application Publication
(10) Pub. No.: US 2005/0244781 A1
(43) Pub. Date: Nov. 3, 2005

(54) Orthodontic treatment method for concurrent correction of multiple conditions

(76) Inventors: Norbert Abels, Homburg (DE); Claus-H. Backes, Saarbrucken (DE)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/013,186

(22) Filed: Dec. 15, 2004

Related U.S. Application Data
(63) Continuation-in-part of application No. 10/835,963, filed on Apr. 30, 2004.
(63) Continuation-in-part of application No. 10/837,477, filed on Apr. 30, 2004.
(63) Continuation-in-part of application No. 10/835,972, filed on Apr. 30, 2004.
(63) Continuation-in-part of application No. 10/836,014, filed on Apr. 29, 2004.

(51) Int. Cl. A61C 3/00

(52) U.S. Cl. 433/24; 433/21

(57) ABSTRACT

A treatment method that can be used to concurrently correct multiple malocclusion conditions. The method involves attaching a set of orthodontic brackets onto a person's teeth, each bracket having at least two arch wire slots. Two or more auxiliary orthodontic devices that concurrently move teeth in multiple ways are then installed. The auxiliary orthodontic devices may be selected from: (1) a torque spring, (2) at least one adjustable bite ramp; (3) Class II elastics; and (4) a single primary arch wire that is not replaced at any time with a larger arch wire, the single primary arch wire being used with a system of brackets having multiple arch wire slots that become substantially aligned when the person's teeth are aligned.

### CROSS-REFERENCE TO RELATED APPLICATION

This application is a continuation-in-part of co-pending U.S. application Ser. No. 10/835,963, filed Apr. 30, 2004, and entitled “ADJUSTABLE BITE RAMPS FOR DEEP BITE CORRECTION AND KITS INCORPORATING BITE RAMPS,” U.S. application Ser. No. 10/837,477, filed Apr. 30, 2004, and entitled “METHOD OF CORRECTING A DEEP BITE CONDITION USING ADJUSTABLE BITE RAMPS,” U.S. application Ser. No. 10/835,972, filed Apr. 30, 2004, and entitled “TORQUE SPRING FOR DOUBLE WIRE ORTHODONTIC TREATMENT,” and U.S. application Ser. No. 10/836,014, filed Apr. 29, 2004, and entitled “ORTHODONTIC BRACKET SYSTEM COMPRISING MULTIPLE BRACKETS HAVING MULTIPLE ALIGNED SLOTS.” The foregoing applications are incorporated herein by reference in their entirety.

### BACKGROUND OF THE INVENTION

1. The Field of the Invention

The present invention relates to orthodontics, more particularly to correction of various malocclusions.

2. The Relevant Technology

Orthodontics is a specialized field of dentistry that involves the application of mechanical forces to urge poorly positioned, or crooked, teeth into correct alignment and orientation. Orthodontic procedures can be used for cosmetic enhancement of teeth, as well as medically necessary movement of teeth or the jaw to correct overjets, overbites, Class II malocclusions, and other conditions. For example, orthodontic treatment can improve the patient's occlusion, or enhanced spatial matching of corresponding teeth.

A Class II malocclusion occurs when the lower jaw is positioned distally relative to the upper jaw. Class II malocclusions are typically referenced from the upper and lower first molars. Overjets occurs when there is excessive horizontal projection of the upper incisors relative to the lower incisors. Overbite, also known as “deep bite,” occurs when there is excessive vertical overlap of the incisors. These conditions can result in increased wear of the incisors, periodontal problems, increasingly visible gum tissue, and increased instances of the patient biting the roof of their mouth. In addition, correction of such conditions often results in a more aesthetically appealing smile for the patient.

Depending on the severity of the condition, correction can sometimes be achieved with installation and use of dental braces, although orthognathic surgery is sometimes required. Installation of dental braces can be ineffective in effecting sufficient movement of the jaw, while orthognathic surgery is expensive, invasive, and uncomfortable, especially from a patient's perspective.

Another type of malocclusion that commonly occurs is a lateral inclination or so called torque of the incisors. A lateral inclination of the incisors may cause the incisors to tip either forward (labially) or backward (lingually). Generally, inclination of the incisors is aesthetically undesirable as it affects the appearance of the person's smile.

Finally, in using an arch wire to apply corrective forces to each tooth, elaborate bends of the arch wire are often necessary to create the desired force to make the intended correction. These bends can be difficult and time consuming to form, and mistakes in the choice and formation of bends can move the teeth in unwanted directions.

Typically, these and other types of malocclusions occur concurrently with each other. Generally, existing methods and apparatus for correcting malocclusions such as these (and others) require a sequential approach. Such a limitation significantly increases the amount of treatment time required as individual issues must be treated in sequence.

Therefore, it would be an improvement in the art to provide a treatment method that can be used to concurrently correct multiple malocclusion conditions.

### BRIEF SUMMARY OF THE PREFERRED EMBODIMENTS

The present invention provides a treatment method that can be used to concurrently correct multiple malocclusion conditions. The method involves attaching a set of orthodontic brackets onto a person's teeth, each bracket having at least two arch wire slots. Two or more auxiliary orthodontic devices that concurrently move teeth in multiple ways are then installed in the patient's mouth. The auxiliary orthodontic devices may be e.g., selected from: (1) a torque spring, (2) at least one adjustable bite ramp; (3) Class II elastics; and (4) a single primary arch wire that is replaced step by step with a larger arch wire, the single primary arch wire being used with a system of brackets having multiple arch wire slots that become substantially aligned when the person's teeth are aligned.

A torque spring may be used to correct a lateral inclination of the incisors. A torque spring includes two curved arch wire portions that are configured to engage secondary arch wire slots of brackets attached to at least a person's canines and bicuspids on either side of a person's incisors. The torque spring also includes two or more bent regions between the curved arch wire portions that substantially frame the selected incisors so as to tip the incisors in a desired direction during an orthodontic treatment. The engagement between the bent regions and the substantially framed incisors causes the incisors to tip in place, e.g., in a labial direction, thereby correcting any abnormal inclination of the incisors.

The torque spring may be used to correct inclination of any of the front teeth. According to one embodiment, it may be used with the first and/or second incisors of the upper or lower dental arch.

The torque spring may be made from any suitable arch wire material. Examples of suitable materials include stainless steel, titanium, and titanium alloys. Preferably, any metals used are substantially nickel free or have a low nickel content so as to avoid patient sensitivity which can sometimes be caused by exposure to nickel.

An adjustable bite ramp may be used to correct an overjet, an “overbite”, also known as a “deep bite” condition, and/or a Class II malocclusion. An adjustable bite ramp includes a tooth-attachment element and a ramp element. The tooth-attachment element is sized and configured for bonding to the lingual surface of a person's upper incisor, while the ramp element is hingedly or pivotally adjustable relative to the tooth-attachment element. The ramp element provides a ramp structure at a desired angle for engaging the lower incisors when the person's mouth is closed. The engagement between the ramp structure and the lower incisors causes the lower jaw to move forward relative to the upper jaw. In this way, the adjustable bite ramp is capable of correcting an overjet, a deep-bite, and a Class II malocclusion simultaneously. Such simultaneous correction may provide reduction in treatment times of one third or more.

The adjustable bite ramps may be made from metal, plastic, or another somewhat flexible material so as to allow adjustment of the ramp element. Suitable metals include stainless steel, titanium, and titanium alloys. Preferably, any metals used are substantially nickel free or have a low nickel content so as to avoid patient sensitivity which can sometimes be caused by nickel. According to one embodiment, the adjustable bite ramps may be injection molded from a plastic.

The adjustable bite ramps may further comprise means for locking the ramp element in a desired adjustment angle relative to the tooth-attachment element. An example of such a means for locking is a curable resin that is applied to and cured between the tooth-attachment and ramp elements. The cured resin locks the ramp element in a desired adjustment angle.

According to one embodiment, an optional shoe may be placed over the adjustable bite ramp. The shoe may be bonded to the adjustable bite ramp with an adhesive. In use, the lower surface of the shoe provides the ramp for engaging the lower incisor. The upper surface provides a smoother surface within the patient's mouth (e.g., to provide enhanced comfort and/or to help prevent buildup of plaque or other foreign matter).

Class II elastics are another auxiliary orthodontic device that may be used for correction of a Class II malocclusion. As known in the art, one end of an elastic device is attached to a hook located on a bracket or band attached to one of the molars of the lower dental arch. The other end of the elastic device may be attached to a hook located on a bracket attached to the canine of the upper dental arch. Alternatively, the elastic device may be attached to a hook that is attached to the arch wire, typically near the canine. Class II elastic devices are available in multiple sizes, each size configured to provide a different amount of force between the lower and upper jaws. The Class II elastic device acts to pull the lower jaw forward relative to the upper jaw.

Another auxiliary orthodontic device that may be used is a single primary arch wire used with brackets that become substantially aligned when the person's teeth are aligned. Such an arch wire and bracket system eliminates the need for elaborate and difficult bends of the arch wire. Each bracket of such a bracket system is sized and configured to be placed on a particular tooth of a patient during an orthodontic treatment procedure. Each bracket includes at least two arch wire slots that lie in different planes. The arch wire slots are positioned relative to the bracket base so that when the patient's teeth have become properly aligned as a result of the orthodontic treatment procedure, the corresponding arch wire slots of all the brackets will be substantially aligned. In other words, the bracket system includes brackets that have unique geometric positioning of the arch wire slots within the bracket base. Each bracket is configured so that when placed on its particular tooth, the arch wire slots of that bracket are substantially aligned with the corresponding arch wire slots of the other brackets of the bracket system when the orthodontic treatment is complete. This, in turn, allows for the continual use of arch wires that remain “straight” throughout the procedure (i.e., have a “straight” or regular curvature with little or no abrupt or irregular bends).

The orthodontic brackets may be configured for placement on either the upper or lower dental arch. For example, the system may include as few as two or as many as fourteen orthodontic brackets, each bracket being configured for placement on one tooth of the upper or lower dental arch.

Each orthodontic bracket included in the system may be specifically configured for placement on a particular tooth or subset of teeth. Whereas aligning the main arch wire slot may be routine, aligning both the main slot and the secondary or auxiliary slots that lie in a different plane may be challenging because of varying tooth size and orientation in normally aligned teeth and corresponding variations in size and shape of brackets for each tooth.

Because of these variations in the size and angle of various teeth of the dental arch, the various brackets intended for placement on those teeth include arch wire slots oriented differently relative to the bonding surface of the bracket base. The arch wire slots of each orthodontic bracket are formed in the bracket base so that when the brackets are placed on the teeth of the dental arch the arch wire slots are substantially aligned once treatment is complete. When treatment is complete, the arch wire will be evenly and smoothly curved, without the need for any deviating bends (which are elaborate and difficult to form).

The orthodontic brackets of the bracket system are self-ligating, i.e., the arch wire is clamped or otherwise held between the ligation cover and the bracket base. The ligating cover is connected to the bracket base, and the cover is movable relative to the bracket base between an open, non-ligating position relative to the arch wire slots and a closed, ligating position relative to the arch wire slots. In other words, at least two arch wire slots are ligated using a single cover.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an exemplary torque spring according to the invention;

FIG. 2A is a perspective view of an exemplary torque spring installed so as to correct inclination of the first upper incisors;

FIG. 2B illustrates termination of the end of the torque spring within an orthodontic bracket bonded to a person's first bicuspid;

FIG. 3A illustrates an upper dental arch with orthodontic brackets bonded to eight of the teeth of the upper dental arch;

FIG. 3B illustrates insertion of a torque spring into the secondary arch wire slots of the orthodontic brackets;

FIG. 3C illustrates insertion of a primary arch wire into the primary arch wire slots of the orthodontic brackets;

FIG. 3D illustrates insertion of a primary arch wire into the primary arch wire slots of the orthodontic brackets;

FIG. 3E illustrates the front eight teeth of an upper dental arch with a torque spring and primary arch wire installed, and the ligating covers of the self-ligating orthodontic brackets having been closed;

FIG. 4A is a perspective view of an exemplary adjustable bite ramp according to the invention;

FIG. 4B is a perspective view of an alternative adjustable bite ramp according to the invention;

FIGS. 5A-5E depict installation of an adjustable bite ramp;

FIGS. 6A and 6B depict an optional shoe that may be used in association with an adjustable bite ramp;

FIGS. 7A and 7B depict an alternative optional shoe that may be used in association with an adjustable bite ramp;

FIG. 8 is a perspective view of a Class II elastic device installed on one side of a patient's upper and lower dental arch;

FIGS. 9A-9B are perspective views of one exemplary orthodontic bracket that may be included in a bracket set according to the present invention;

FIGS. 10A-10B are perspective views of one exemplary orthodontic bracket that may be included in a bracket set according to the present invention;

FIGS. 11A-11B are perspective views of one exemplary orthodontic bracket that may be included in a bracket set according to the present invention;

FIG. 12A is a perspective view of an alternative orthodontic bracket design that may be included in an inventive bracket set, and where the bracket is in an open, non-ligating position;

FIG. 12B is a perspective view of an alternative orthodontic bracket design that may be included in an inventive bracket set, and where the bracket is in a closed, ligating position;

FIGS. 13A-13C are perspective views of various orthodontic brackets after the design of the bracket of FIG. 12A that may be included in a bracket system according to the present invention;

FIG. 14 is a top perspective view of an exemplary bracket system installed wherein the arch wire slots of the various brackets are substantially aligned after treatment is complete; and

FIG. 15 is a view of the orthodontic brackets of FIGS. 9A-11B where the plurality of brackets having substantially aligned arch wire slots are viewed from the perspective of an evenly curved arch wire retained within the brackets.

### DETAILED DESCRIPTION OF THE PREFERRED EMBODIMENTS

I. Introduction

The present invention provides a treatment method that can be used to concurrently correct multiple malocclusion conditions: a) single dental arch alignment; b) torque of the teeth from the beginning without full slot engagement; c) bite-opening with the help of adjustable bite ramps (disocclusion); d) additional comfortable Class II correction; and e) additional clinical necessities such as e.g., space openers and space closers. The method involves attaching a set of orthodontic brackets onto a person's teeth, each bracket having at least two arch wire slots. Two or more auxiliary orthodontic devices that concurrently move teeth in multiple ways are then installed. The auxiliary orthodontic devices may be selected from: (1) a torque spring, (2) at least one adjustable bite ramp; (3) Class II elastics; and (4) a single primary arch wire that is not replaced step by step with a larger arch wire, the single primary arch wire being used with a system of brackets having multiple arch wire slots that become substantially aligned when the person's teeth are aligned.

II. A Torque Spring

A torque spring may be used to correct a lateral inclination of the incisors. A torque spring includes two curved arch wire portions that are configured to engage secondary arch wire slots of brackets attached to at least a person's canines and bicuspids on either side of a person's incisors. The torque spring also includes two or more bent regions between the curved arch wire portions that substantially frame selected incisors so as to tip the incisors in a desired direction during an orthodontic treatment. The engagement between the bent regions and the framed incisors causes the framed incisors to tip in place, either lingually or labially, thereby correcting any abnormal inclination of the incisors.

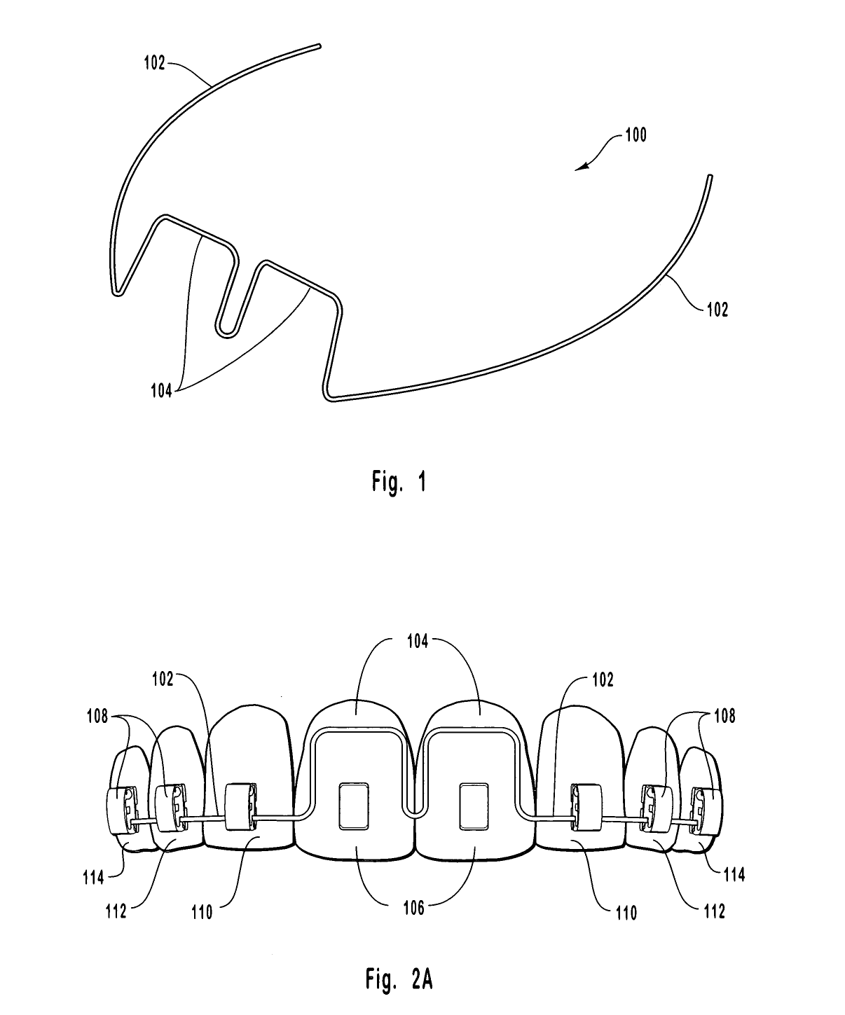

FIG. 1 illustrates an exemplary torque spring 100. The torque spring 100 includes curved arch wire portions 102 and two (more could be included) bent regions 104. The two curved arch wire portions 102 are configured to engage secondary arch wire slots of orthodontic brackets attached to the teeth adjacent to the incisors to be tipped. The bent regions 104 are situated between the curved arch wire portions 102 and are configured so as to substantially frame the incisors to be tipped. The illustrated embodiment substantially frames just the first incisors. Alternative embodiments may include different configurations that frame the second incisors or any combination of first and second incisors. Contact between the bent regions 104 and the incisors applies the necessary force to tip the inclined incisors as desired, either lingually or labially.

The torque spring 100 may be made from any suitable arch wire material. Examples of suitable materials include stainless steel, titanium, and titanium alloys. Preferably, any metals used are substantially nickel free or have a low nickel content so as to avoid patient sensitivity which can sometimes be caused by exposure to nickel.

FIGS. 2A-2B illustrate torque spring 100 having been installed so as to correct an inclination of the first incisors 106. The curved arch wire portions 102 are engaged within the secondary arch wire slots of brackets 108 bonded to the second incisors 110, canines (or cuspids) 112, and first bicuspids 114. The bent regions 104 substantially frame the first incisors 106 and apply a correcting force to the first incisors 106.

As better seen in FIG. 2B, and according to one embodiment, the torque spring 100 terminates at the bracket bonded to the person's first bicuspid 114. It is, of course, within the scope of the invention to terminate the torque spring at any appropriate tooth depending on which incisors are being treated and/or how long the curved arch wire portions 102 are. By way of example, a torque spring used to correct the first incisors and long enough to span ten teeth will terminate at the brackets attached to the second bicuspids. Similarly, a torque spring used to correct the first and second incisors in the right quadrant of a patient's teeth and long enough to span eight teeth will terminate at the brackets attached to the left canine (or cuspid) and the right second bicuspid.

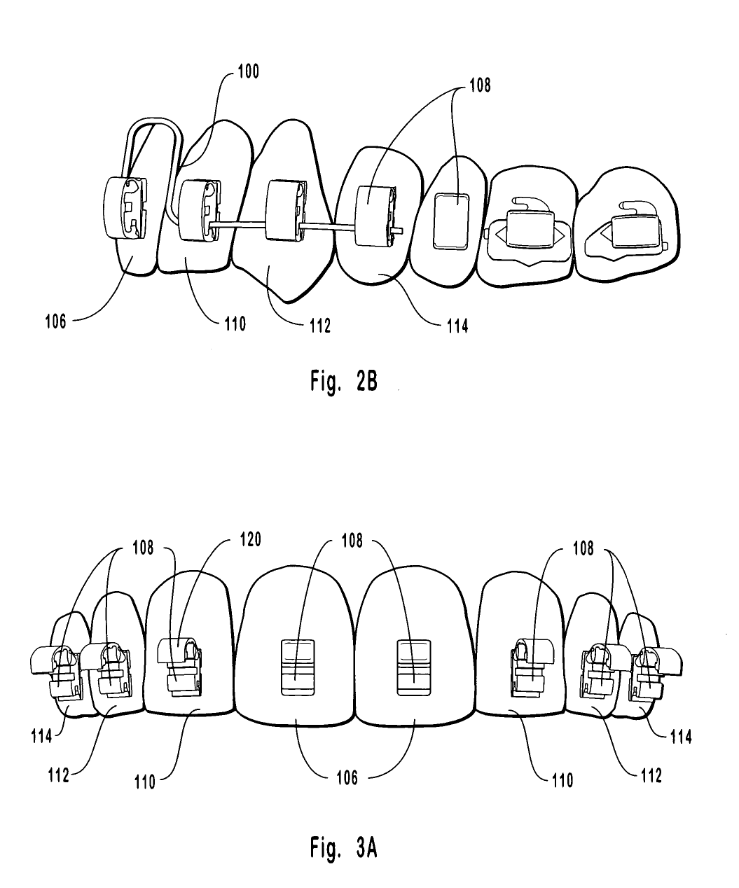

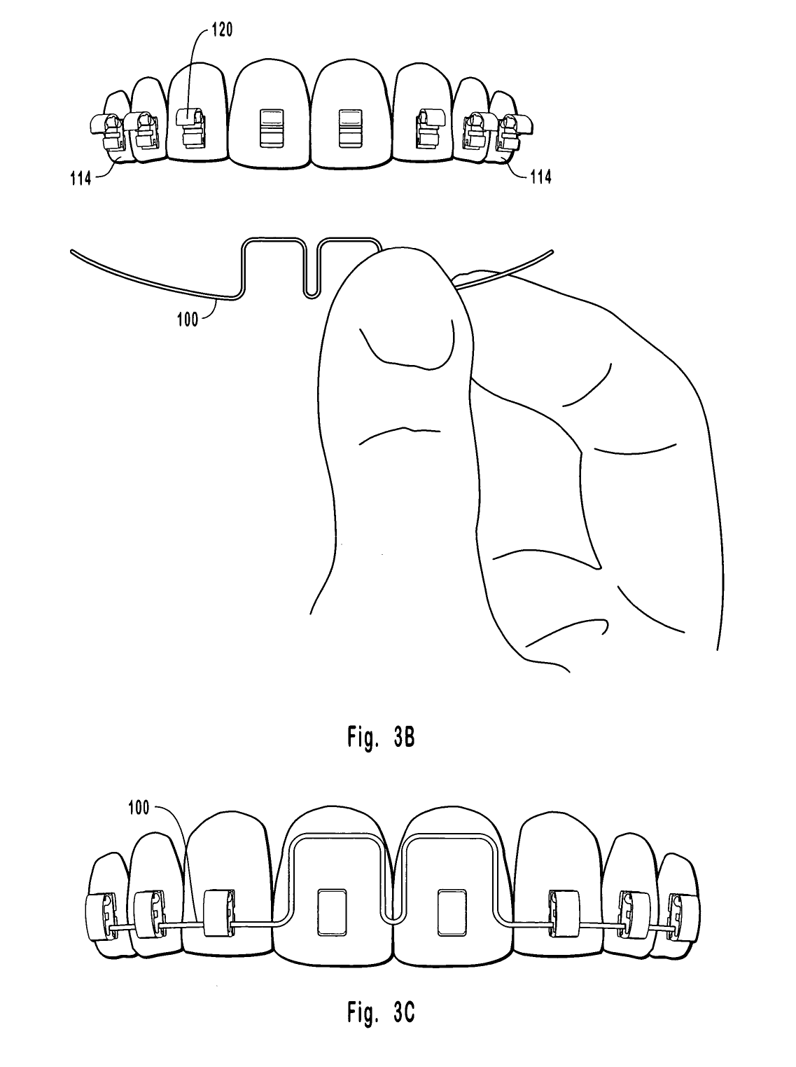

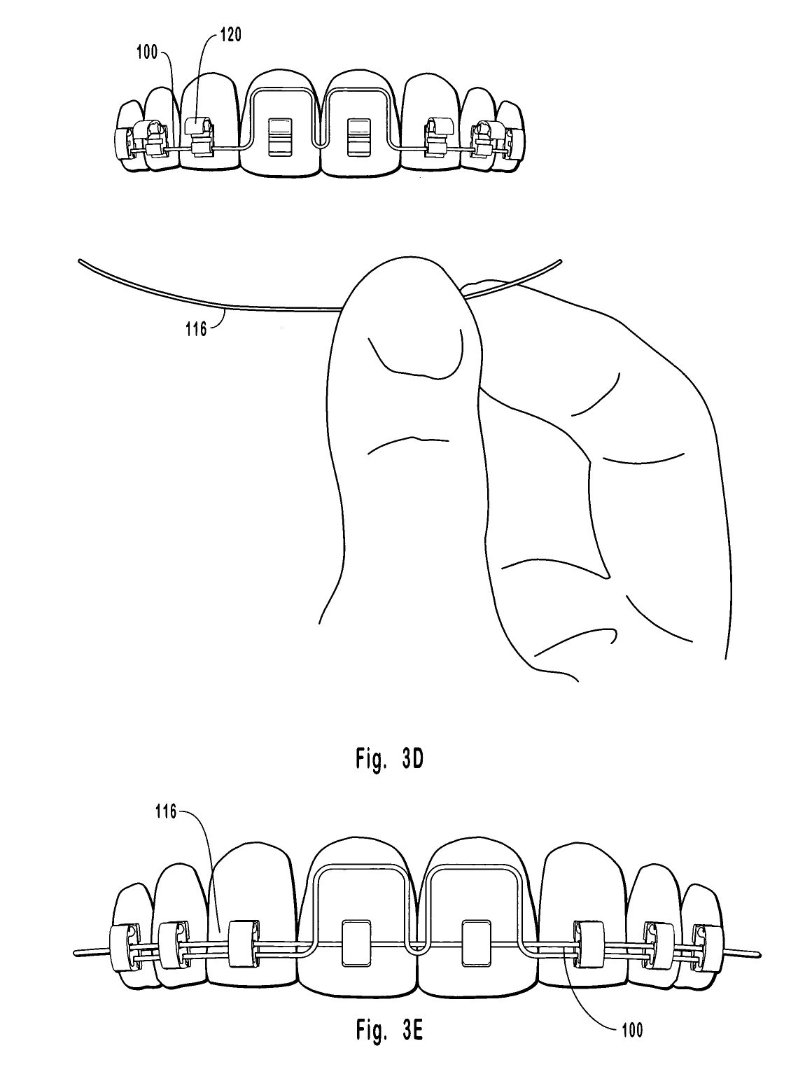

FIGS. 3A-3E illustrate an exemplary method of installing and using the torque spring 100. FIG. 3A shows an upper dental arch where self-ligating orthodontic brackets have been bonded to eight of the teeth of the upper dental arch. The ligation covers 120 of the brackets 108 are in the open, non-ligating position, ready to receive a torque spring and primary arch wire.

Thereafter, the ends of curved arch wire portions 102 of torque spring 100 are inserted into the secondary arch wire slots of the orthodontic brackets bonded to the first bicuspids 114, as illustrated in FIG. 3B. The curved arch wire portions 102 are also inserted into the secondary arch wire slots of the orthodontic brackets bonded to the person's second incisors 110 and canines (or cuspids) 112. The bent regions 104 between the curved arch wire portions 102 are then adjusted so as to apply the desired torquing force so as to tip the first incisors 106 in a desired manner during treatment. The ligation covers 120 of the self-ligating orthodontic brackets may then be closed so as to retain the torque spring 100 within the secondary arch wire slots of the brackets, as shown in FIG. 3C.

Alternatively, the torque spring 100 may be used concurrently with a primary arch wire for correcting the spacing and orientation of teeth. In this way, the primary arch wire may be placed in the primary arch wire slots of orthodontic brackets placed on the teeth of the person while the torque spring is used to concurrently tip any of the first or second incisors. FIG. 3D illustrates insertion of a primary arch wire 116 into the primary arch wire slots of the orthodontic brackets 108 bonded to eight of the teeth of the upper dental arch, with the ligation covers 120 being open to receive the primary arch wire 116 within the primary arch wire slots. The covers 120 of the brackets 108 on the first bicuspids (or any other desired tooth) may remain closed so as to hold the torque spring in place. FIG. 3E illustrates the dental arch after all ligation covers of the orthodontic brackets have been closed. It will be appreciated that the primary arch wire 116 may be received within brackets attached to any or all of a patient's second bicuspids and first and second molars.

Although illustrated in conjunction with treatment of the first incisors of the upper dental arch, the torque spring could alternatively be used for correction of any inclination of any of the incisors, in a similar manner. For example, the torque spring may be shifted to the left or to the right to correct first and second incisors on either the left or right quadrant of teeth. Alternatively, the torque spring may include bent regions that substantially frame three or four incisors in order to correct inclination of three or four incisors, respectively.

It will also be appreciated that the inventive torque springs may be used with other types of orthodontic brackets in addition to, or instead of, the self-ligating brackets illustrated in the drawings, including, but not limited to, other types of self-ligating brackets and/or non-self-ligating brackets that require ligatures to retain the torque spring and/or primary arch wire within the slots.

III. Adjustable Bite Ramps

The adjustable bite ramps of the present invention include a tooth-attachment element and a ramp element. The tooth-attachment element is sized and configured for bonding to the lingual surface of a person's upper incisor, while the ramp element is hingedly or bendably adjustable relative to the tooth-attachment element. The ramp element provides a ramp structure at a desired angle for engaging the lower incisors when the person's mouth is closed. The engagement between the ramp and the lower incisors causes the lower jaw to move forward relative to the upper jaw.

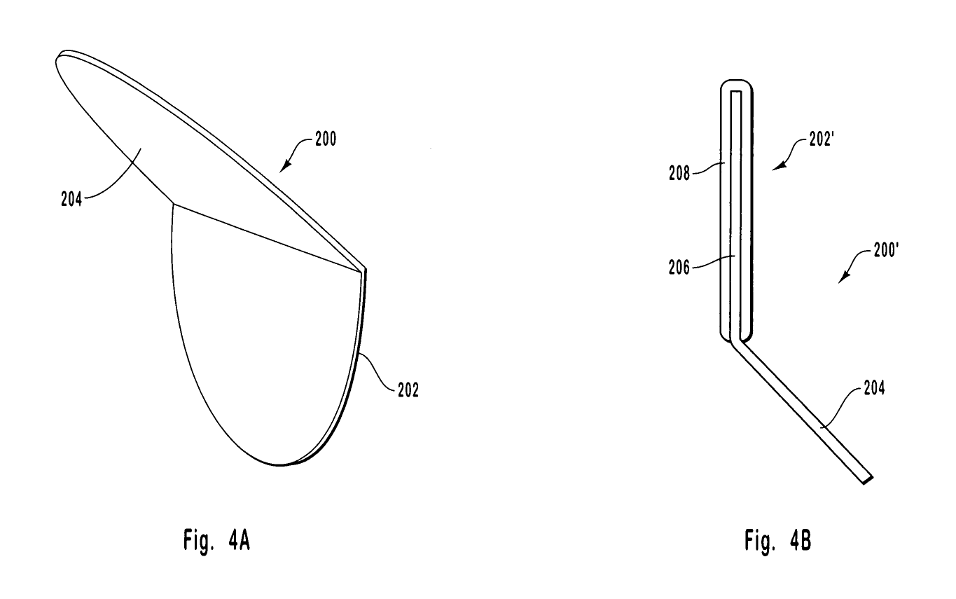

FIG. 4A illustrates an exemplary adjustable bite ramp 200. The adjustable bite ramp 200 includes a tooth-attachment element 202 and a ramp element 204. The tooth-attachment element 202 is configured for bonding to the lingual surface of a person's upper incisor. In the illustrated embodiment, the ramp element 204 is bendably adjustable relative to the tooth-attachment element 202. The adjustability of the ramp element 204 provides a ramp structure at a desired angle for engaging the lower incisor upon closing the person's mouth.

The adjustable bite ramps 200 may be made from metal, plastic, or another suitable material (e.g., a strip crown) so as to allow adjustment of the ramp structure. Suitable metals include stainless steel, titanium, and titanium alloys. Preferably, any metals used are substantially nickel free or have a low nickel content so as to avoid patient sensitivity which can sometimes be caused by nickel. According to one embodiment, the adjustable ramps may be injection molded from a plastic.

FIG. 4B illustrates an alternative embodiment of an adjustable bite ramp 200′. Adjustable bite ramp 200′ includes a tooth-attachment element 202′ and a ramp element 204. The tooth-attachment element 202′ comprises an underlying support structure 206 that is integrally attached to the ramp element 204 and that further includes a polymer cover 208 that is overmolded over at least a portion of the support structure 206. The support structure may include holes or perforations (not shown) that aid in mechanically interconnecting the overmolded polymer cover 208 over the support structure 206. The purpose of the polymer cover 208 is to provide a bonding surface that is more chemically compatible with adhesive bonding agents that may be used to adhere the tooth-attachment element 202′ to a person's tooth during use. The polymer cover 208 may optionally include undercuts (not shown) in order to promote better interaction and bonding between the polymer cover 208 and an adhesive. According to one embodiment, the polymer cover 208 may be curved to match the curvature of the lingual surface of an upper incisor.

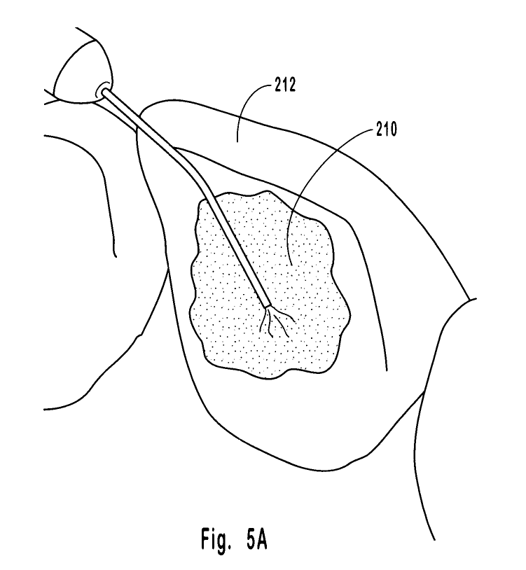

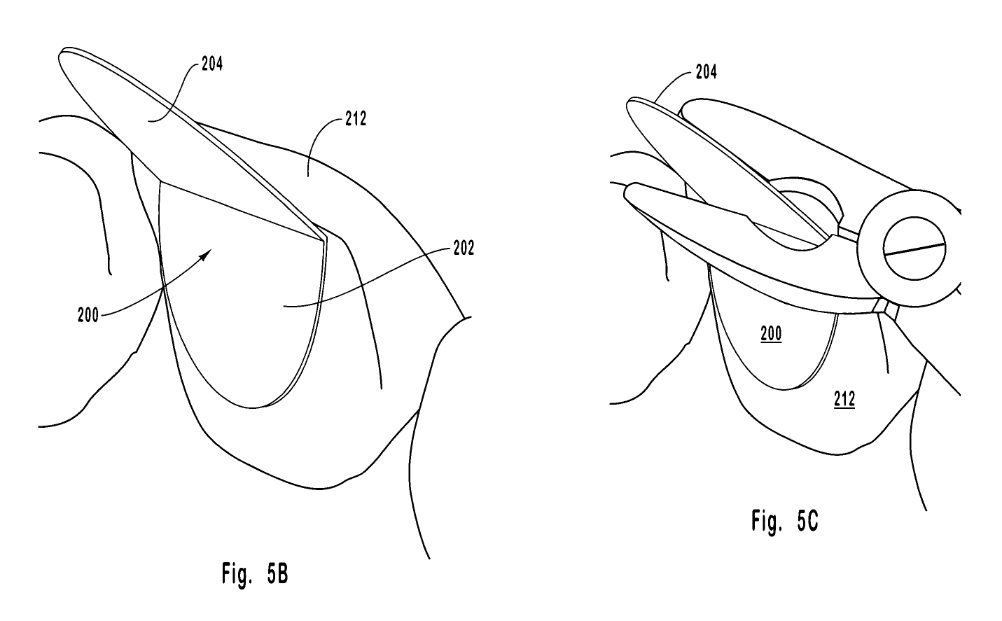

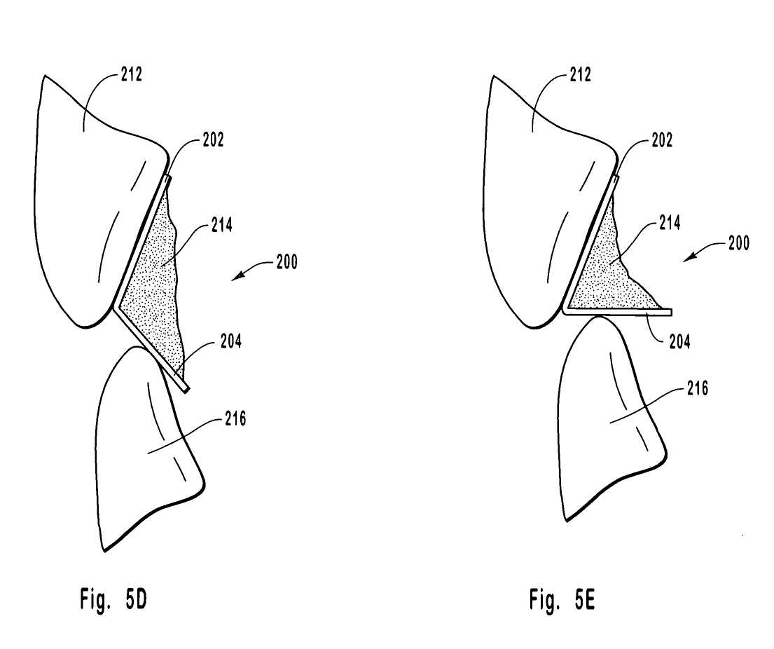

FIGS. 5A-5E illustrate an exemplary method of attaching the adjustable bite ramp 200 to a tooth. FIG. 5A shows an adhesive 210 being applied to the lingual surface of an upper incisor 212. The tooth-attachment element 202 of an adjustable bite ramp 200 is then positioned as desired on the lingual surface of incisor 212, as illustrated in FIG. 5B. Adhesive 210 may be any light or chemically curable adhesive resin known in the art of dentistry to adhere an appliance to a tooth.

The ramp element 204 of adjustable bite ramp 200 is then adjusted (e.g., by bending) to provide a ramp structure at a desired angle, as illustrated in FIG. 5C. Any suitable tool for adjusting the ramp angle may be used (e.g., pliers, probes, or even a finger).

Once the ramp element 204 has been adjusted as desired, the area between the tooth-attachment element 202 and ramp element 204 of adjustable bite ramp 200 may be filled with a light or chemically curable composition 214 (e.g., a filled composite resin used to fill teeth or a luting cement). The composition 214 is cured and hardened so as to lock the ramp element 204 in the desired adjustment angle relative to tooth-attachment element 202, as illustrated in FIG. 5D. Such a curable composition 214 is an example of means for locking a ramp element in a desired adjustment angle relative to a tooth-attachment element.

FIG. 5D also illustrates how the adjustable bite ramp 200, more particularly the ramp element 204, engages the lower incisor 216 as the person's mouth is closed. The engagement between the ramp element 204 and the lower incisor 216 applies a force causing a person's lower jaw to move forward relative to the upper jaw.

The ramp element 204 of adjustable bite ramp 200 may be adjusted to provide a ramp structure at any desired angle. FIG. 5D illustrates the ramp element 204 having been adjusted so as to provide an oblique angle between the tooth-attachment element 202 and the ramp element 204. FIG. 5E alternatively illustrates a ramp element 204 having been adjusted so as to provide an acute angle between the tooth-attachment element 202 and the ramp element 204. The exact angle between the ramp element 204 and tooth-attachment element 202 may be selected depending on one or more of the relative positions of the upper and lower jaws, size of the person's teeth, angle of the teeth, desired degree of correction, and the like.

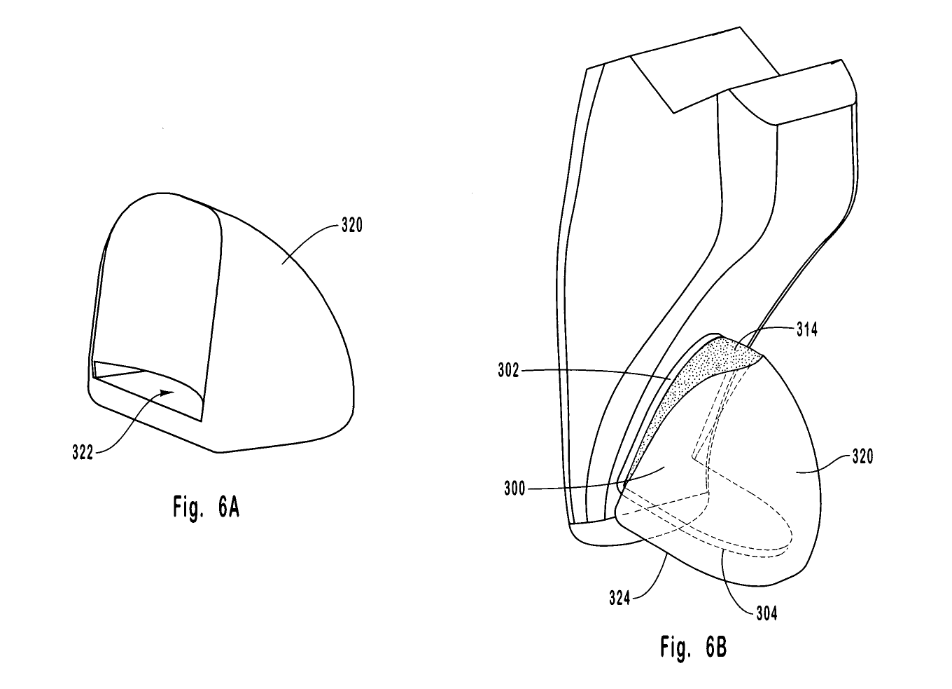

The adjustable bite ramps of the invention may optionally be used in combination with a shoe. FIGS. 6A and 6B illustrate an optional shoe 320 for use with an adjustable bite ramp 300. The shoe 320 may be placed over the ramp element 304 of bite ramp 300, more particularly by inserting ramp element 304 into a receiving slot 322 in the shoe 320. The shoe 320 may be bonded to the adjustable bite ramp 300 by use of an adhesive. When used, a lower surface 324 of the shoe 320 provides a ramp surface for slidable engagement with the lower incisor. As illustrated, the upper surface of the shoe 320 may be rounded so as to provide a smooth surface for increased patient comfort and/or to prevent build-up of plaque or debris.

The shoe 320 may be adapted to form a flush fit against the person's incisor, more particularly, the tooth-attachment structure 302 of the bite ramp 300. After adjustment of the ramp element 304, a space may exist between the shoe 320 and the tooth-attachment element 302, which is advantageously filled with a curable composition 314.

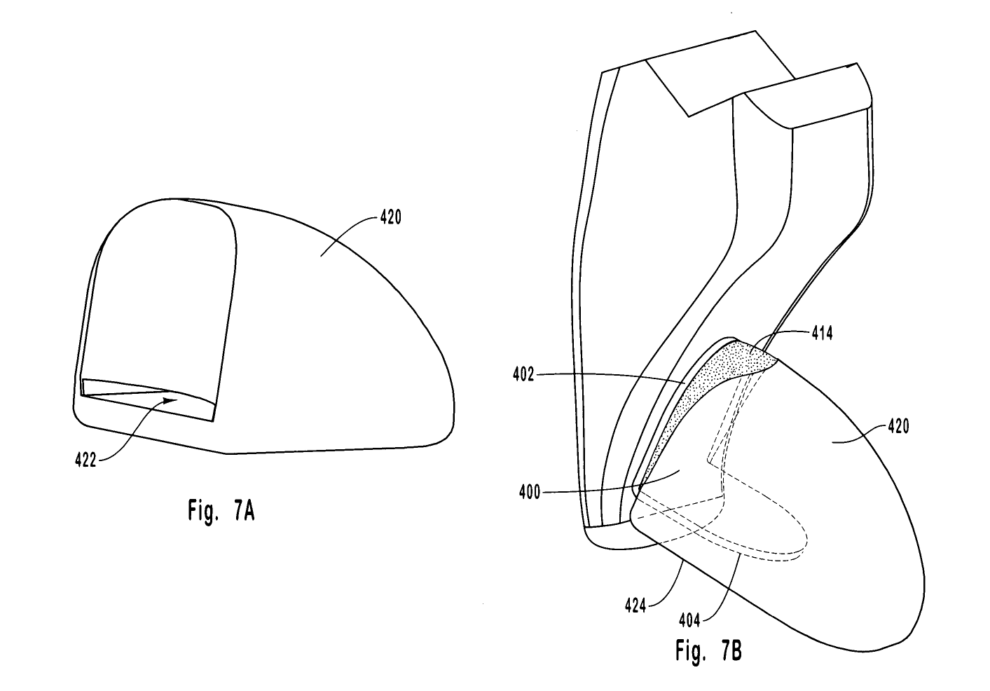

FIGS. 7A and 7B illustrate an alternative embodiment of a shoe 420 that is used in the same manner as shoe 320 illustrated in FIGS. 6A and 6B, except that the lower surface 424 of the shoe 420 is significantly longer than surface 324 of shoe 320. Providing an increased working length of the lower surface 424 may be desirable for treating more severe or deeper overbites, overjets, and Class II malocclusions.

During treatment, it may be desirable to begin treatment with a longer shoe 420 such as that illustrated in FIGS. 7A-7B. According to one embodiment, the shoe may be formed of a material (e.g., PEEK polyarylether ketone) that will form a weaker bond with the resin 414 used to fill space between the shoe 420 and tooth-attachment element 402 as compared to the bond between the tooth-attachment element 402 or an optional overmolded polymer cover (see FIG. 4B) (e.g., formed of a polymer such as TROGAMID nylon) and the filling resin 414. Using such a material allows preferential separation of the shoe 420 from the filling resin 414. As treatment progresses, the lower jaw is pulled forward relative to the upper jaw. Once the lower jaw has been pulled sufficiently forward, the longer shoe 420 may be removed and replaced with a shorter shoe, such as shoe 320 illustrated in FIGS. 6A-6B, which is less intrusive within the mouth of the patient.

Alternatively, treatment may begin with a longer shoe, such as that illustrated in FIGS. 7A-7B, and once the lower jaw has been pulled sufficiently forward, the end of the shoe may be ground or cut so as to form a shoe of a shorter length, which is less intrusive within the mouth of the patient.

IV. Class II Elastics

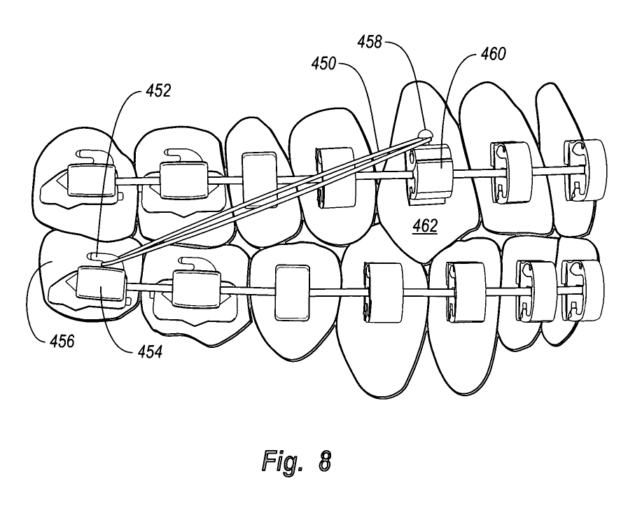

Class II elastics are another auxiliary orthodontic device that may be used for correction of a Class II malocclusion. As illustrated in FIG. 8, one end of an elastic device 450 is attached to a hook 452 located on a bracket 454 attached to molar 456 of the lower dental arch. The other end of the elastic device 450 is shown attached to another hook 458 attached to a bracket 460 bonded to canine 462 of the upper dental arch.

Although shown attached to a hook 452 of bracket 454 and hook 458 attached to bracket 460, hooks 452 and 458 may be attached to brackets, an arch wire, or to a band attached to a tooth, as desired. Class II elastic devices may be available in multiple sizes, each size configured to provide a different amount of force between the lower and upper jaws. The Class II elastic device 450 acts to pull the lower jaw forward relative to the upper jaw.

V. A Single Primary Arch Wire and a Bracket System with Aligning Slots

Another auxiliary orthodontic device that may be used is a single primary arch wire used with brackets that become substantially aligned when the person's teeth are aligned. Such an arch wire and bracket system eliminates the need for elaborate bends of the arch wire.

Each bracket of such a bracket system is sized and configured to be placed on a particular tooth or subset of teeth of a patient during an orthodontic treatment procedure. Each bracket includes at least two arch wire slots that lie in different planes. The arch wire slots are positioned relative to the bracket base so that when the patient's teeth have become properly aligned as a result of the orthodontic procedure, the corresponding arch wire slots of all the brackets will be substantially aligned. In other words, the corresponding arch wire slots of all the brackets are aligned so that an arch wire engaged in the slots is “straight,” having little or no abrupt or irregular bends along the length of the arch wire.

The orthodontic brackets of the system may be configured for placement on either the upper or lower dental arch. For example, the system may include as few as two or as many as fourteen orthodontic brackets, each configured for placement on one tooth of the upper or lower dental arch. Separate systems of brackets may be provided for the upper and lower dental arches.

Each orthodontic bracket included in the system may be specifically configured for placement on a particular tooth or subset of teeth. Because of variations in the size and angle of various teeth of an ideal, corrected dental arch, the various brackets intended for placement on those teeth include arch wire slots oriented differently relative to the bonding surface of the bracket base. The arch wire slots of each orthodontic bracket are formed in the bracket base so that when the brackets are placed on the teeth of the dental arch the arch wire slots are substantially aligned once treatment is complete. When treatment is complete, the arch wire will be evenly and smoothly curved, without any deviating bends.

Because of the variation in size, position, and angle of each tooth of an ideal, corrected dental arch, the labial surface of each tooth defines a plane. Each defined plane is unique. In order to use a “straight” arch wire (i.e., one having a regular curvature with little or no abrupt or irregular bends), the arch wire must pass through a point of each plane defined by each corrected tooth. The arch wire slots of each orthodontic bracket bonded to each tooth must be positioned so that the arch wire is “straight.” The position and orientation of each arch wire slot is configured to create such an alignment when the teeth have been moved to a correct or ideal configuration.

According to one embodiment, each orthodontic bracket included in the bracket system includes a bracket base, at least two arch wire slots, and a ligating cover. Including at least two arch wire slots allows concurrent treatment of multiple conditions. The bracket may optionally be formed as one single piece, requiring no assembly. This reduces the cost and complexity of manufacture and prevents unwanted separation of the bracket parts. Attention is now turned to the drawings, which illustrate an exemplary orthodontic bracket system according to the invention.

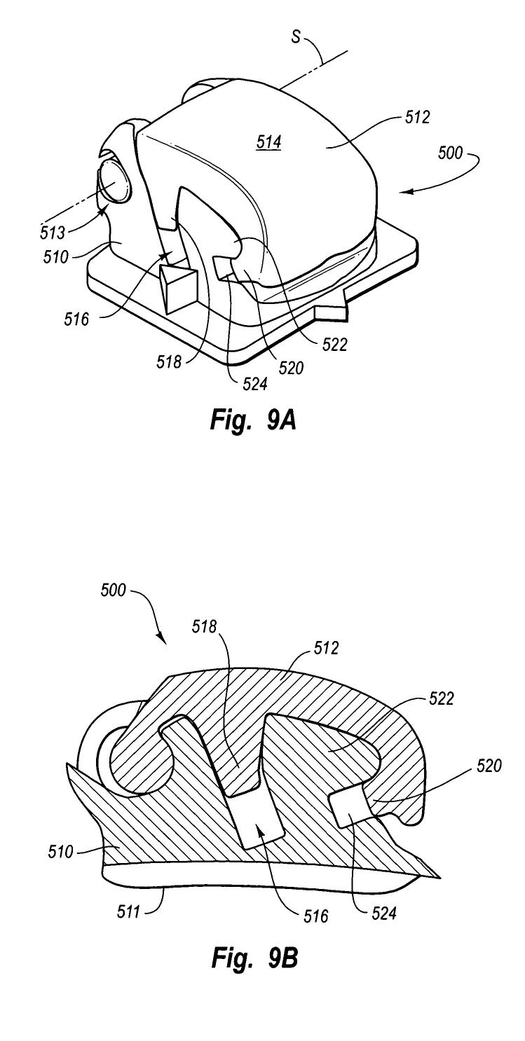

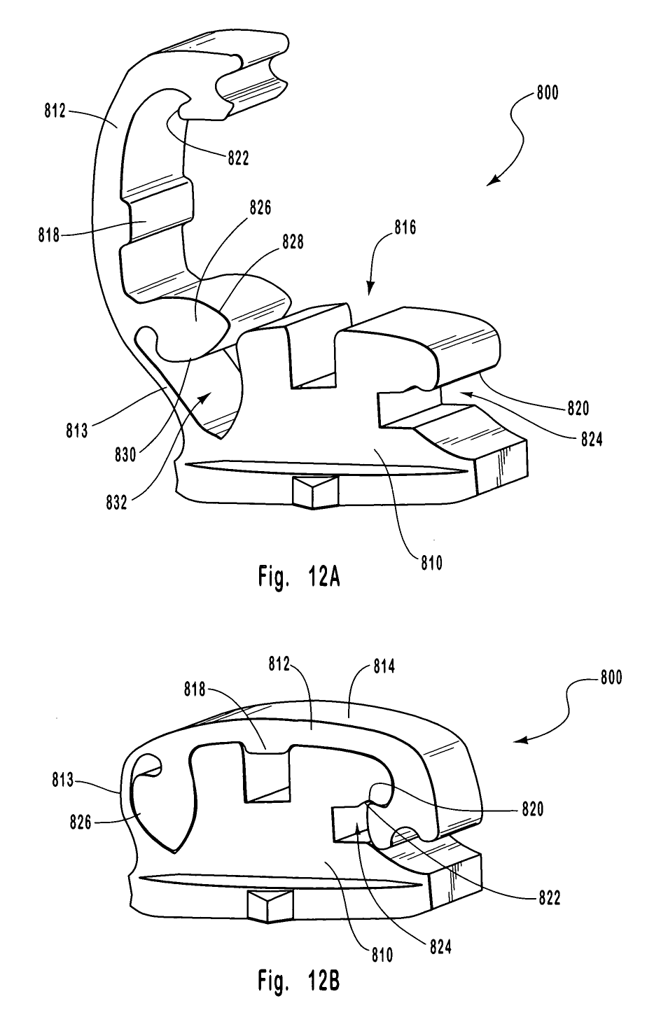

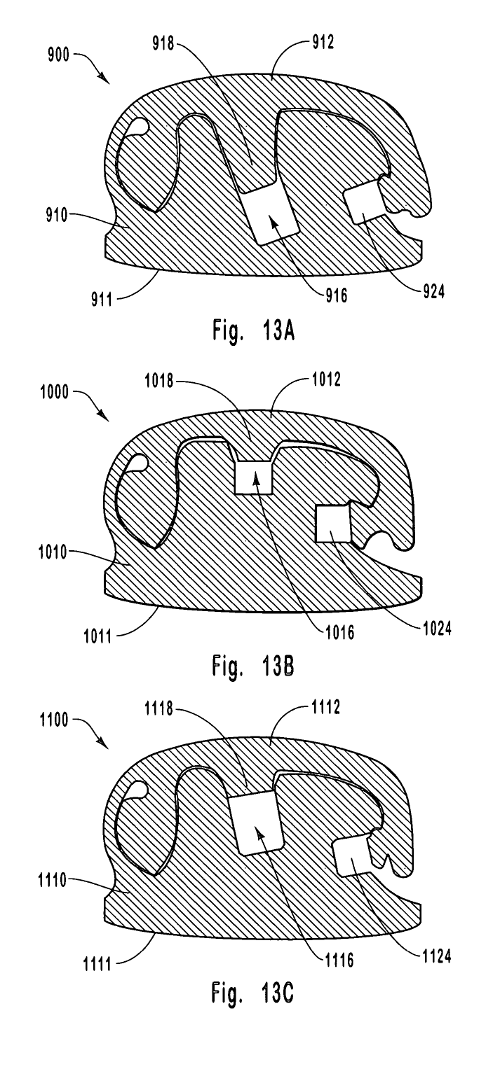

Orthodontic brackets of various designs may be incorporated in an orthodontic bracket system according to the present invention. FIGS. 9A-11B illustrate various examples of such brackets according to one design. An alternative bracket design is illustrated in FIGS. 12A-13C. These and other bracket designs that could be used are disclosed in U.S. patent application Ser. No. 10/464,615 titled “ORTHODONTIC BRACKET WITH ELONGATE FILM HINGE” filed Jun. 18, 2003, U.S. patent application Ser. No. 10/782,487 titled “A TWO PART ORTHODONTIC BRACKET,” filed Feb. 19, 2004, and U.S. patent application Ser. No. 10/836,074 titled “MOLAR ORTHODONTIC BRACKETS HAVING A HINGED BRACKET COVER” filed Apr. 30, 2004, each of which are herein incorporated by reference.

FIG. 9A shows a two-part orthodontic bracket 500 which consists of a base 510 and a ligation cover 512. The base 510 and cover 512 are pivotally connected to each other via a joint 513 which has a horizontal pivot axis S about which the cover 512 can be rotated between open and closed positions.

In the embodiment shown, the cover 512 includes a smooth, curved outer surface 514. It will be appreciated that the cover 512 can have other shapes as desired to yield an orthodontic bracket having a desired configuration and functionality.

As further illustrated in FIG. 9A, the cover 512, while in a completely closed or latched state relative to the base 510, covers or occludes primary arch wire slot 516 designed to receive therein an arch wire (not shown). The cover 512 is advantageously provided with an extension 518 designed to bear against and hold an arch wire in primary slot 516 when the cover 512 is closed or latched relative to the base 510, as better seen in FIG. 9B.

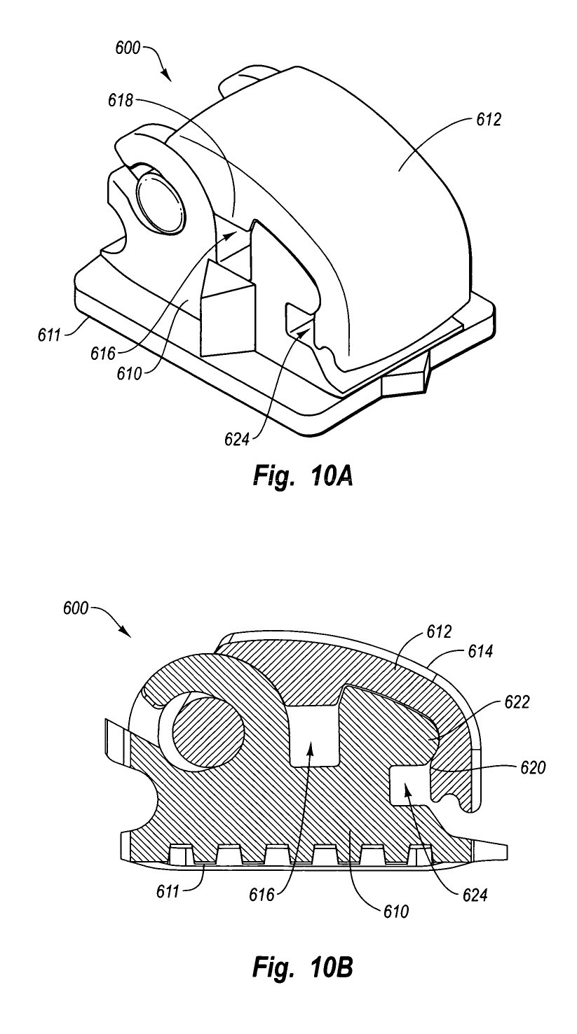

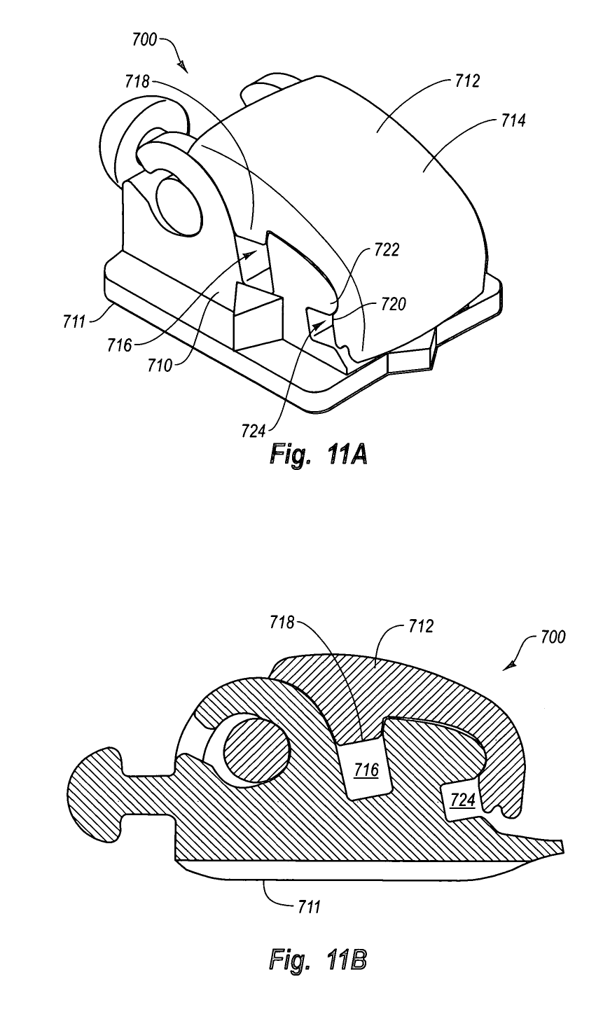

It will be observed that the bottom surfaces of primary and secondary arch wire slots 516 and 524, respectively, are inclined relative to the bonding surface 511 of the base 510. The arch wire slots 516 and 524 are located and oriented within the bracket base 510 so as to be substantially aligned with the other slots of the bracket system once the orthodontic treatment is complete. In other words, the orientation of each slot of each bracket within the bracket system is configured so as to result in all corresponding (e.g., all primary or all secondary) arch wire slots being substantially aligned once the orthodontic treatment is complete. An orthodontic bracket having an arch wire orientation as illustrated in FIGS. 9A-9B may be particularly suited for attachment to the bicuspid. Additional exemplary brackets having different arch wire orientations are will be described in conjunction with FIGS. 10A-11B.

In the closed or latched state, the cover 512 and base 510 of the bracket 500 form a substantially uniformly curved surface 514 having no sharp or jagged corners or edges that might irritate a user of the bracket 500. This prevents or reduces potential injury and discomfort to the patient, as well as the tendency of food or other foreign substances to catch or adhere to the bracket 500.

The bracket 500 may further include a locking mechanism. Cover 512 includes a latch projection 520 provided at an end of the cover 512 distal to the joint 513. The latch projection 520 generally extends toward the base 510 and is configured so as to snap over a latch bump 522 provided at the base 510 in order to mechanically latch the cover 512 to the base 510.

As shown in FIGS. 9A-9B, an secondary arch wire slot 524 may be provided in the base 510 in the region of the latch projection 520, which, in one embodiment, extends parallel to the primary arch wire slot 516 and is likewise covered when the cover 512 is completely closed or latched so as to fix or ligate an arch wire that may optionally be provided in the secondary arch wire slot 524.

The joint 513 is configured so as to permit the cover 512 to have multiple degrees of freedom of movement relative to the base 510 while in the open position. These and other features of the bracket are further disclosed in U.S. patent application Ser. No. 10/782,487 titled “A TWO PART ORTHODONTIC BRACKET,” filed Feb. 19, 2004 already incorporated herein by reference.

FIGS. 10A-10B illustrate another orthodontic bracket 600 that may be included in a bracket system according to the invention. The bracket 600 includes a bracket base 610, a cover 612 forming a substantially uniformly curved surface 614, a primary arch wire slot 616, a bearing extension 618, a latch projection 620, a latch bump 622, and a secondary arch wire slot 624.

The bottom surface of the primary and secondary arch wire slots 616 and 624, respectively, are parallel relative to the bonding surface 611 of the base 610. The arch wire slots 616 and 624 are located and oriented within the bracket base 610 so as to be substantially aligned with the other slots of the bracket system once the orthodontic treatment is complete. In other words, the orientation of each slot of each bracket within the bracket system is configured so as to result in all corresponding (e.g., all primary or all secondary) arch wire slots being substantially aligned once the orthodontic treatment is complete. An orthodontic bracket having an arch wire orientation as illustrated in FIGS. 10A-10B may be particularly suited for attachment to the incisor.

FIGS. 11A-11B illustrate another orthodontic bracket 700 that may be included in a bracket system according to the invention. The bracket 700 includes a bracket base 710, a cover 712 forming a substantially uniformly curved surface 714, a primary arch wire slot 716, a bearing extension 718, a latch projection 720, a latch bump 722, and a secondary arch wire slot 724.

The bottom surface of the primary and secondary arch wire slots 716 and 724, respectively, are inclined relative to the bonding surface 711 of the base 710. The inclination of the bottom of the primary arch wire slot 716 and secondary arch wire slot 724 is less than the inclination of bracket 500 illustrated in FIGS. 9A-9B. The arch wire slots 716 and 724 are located and oriented within the bracket base 710 so as to be substantially aligned with the other slots of the bracket system once the orthodontic treatment is complete. In other words, the orientation of each slot of each bracket within the bracket system is configured so as to result in all corresponding (e.g., all primary or all secondary) arch wire slots being substantially aligned once the orthodontic treatment is complete. An orthodontic bracket having an arch wire orientation as illustrated in FIGS. 11A-11B may be particularly suited for attachment to the canine.

FIGS. 12A and 12B depict an alternative orthodontic bracket design. Orthodontic bracket 800 includes a bracket base 810 to which a ligation cover 812 is hingedly attached. A primary arch wire slot 816 open to the upper side of the bracket base 810 is provided near the center of the base 810 and serves for the receipt of an arch wire therein. The orthodontic bracket 800 also includes a secondary arch wire slot 824. Ligation of both arch wire slots is accomplished by closing the ligation cover 812 over the bracket base 810. An extension 818 is provided in the cover 812 so as to bear against and hold an arch wire in primary slot 816 when the cover 812 is closed or latched relative to the base 810, as better seen in FIG. 12B.

The orthodontic bracket 800 includes an elongate film hinge 813 that is attached at one end to the bracket base 810 and at an opposite end to the ligation cover 812. In this way, the ligation cover 812 is hingedly attached to the bracket base 810 and is able to be selectively rotated between an open, non-ligating position and a closed, ligating position relative to the bracket base 810, more particularly the arch wire slots 816, 824.

Because the film hinge 813 is elongated, it is able to bend gradually over its entire length rather than at a single point or line. This results in a hinge that is more resilient and durable over time because it is not overly bent or stressed at any particular point or line along its length. Moreover, because the elongate film hinge can bend gradually over substantially its entire length, it can be of a thicker, stronger construction compared to a film hinge that bends at a single point or line. This results in a hinge that is significantly stronger and more resistant to breakage compared to other film hinges. In order to maximize strength while providing sufficient bendability, the elongate film hinge is advantageously formed as thick as possible to provide maximum strength while being sufficiently thin to allow the hinge to bend with sufficient flexibility and resilience when in use.

The illustrated embodiment also includes a curved surface that interacts with the elongate film hinge to assist in causing the hinge to bend gradually along substantially its entire length as the ligation cover is selectively rotated relative to the bracket base. This curved surface may either comprise an integral part of the ligation cover or bracket base, or alternatively, a separate piece attached to the cover or bracket base. In one embodiment, the curved surface may be part of a cam structure that is integrally attached to the ligation cover, as illustrated in FIG. 12A.

In FIG. 12A, a cam structure 826 is illustrated that has a camming surface 828 and a curved hinge-guiding surface 830. The hinge-guiding surface 830 is an example of a curved surface that interacts with the elongate film hinge 813 to assist in gradually bending the film hinge along substantially its entire length as the ligation cover 812 is rotated relative to the bracket base 810. The hinge-guiding surface 830 is advantageously curved so as to interact with the elongate film hinge 813 by distributing forces along substantially its entire length as the ligation cover 812 is rotated. Distributing forces along the length of the elongate film hinge 813, rather than allowing the forces to concentrate at a single location, results in a hinged bracket that is more resistant to breakage of the film hinge compared to brackets in which the film hinge is bent abruptly at a specific point or line. In one embodiment, the hinge-guiding surface 830 may help maintain the ligation cover 812 (in combination a latch mechanism) in the locked position by exerting outward pressure against the elongate film hinge 813. This, in turn, effectively shortens length of the ligation cover 812, thereby causing the exemplary latch mechanism to hold the ligation cover 812 more tightly.

The camming surface 828 is curved or angled in such a way so that it interacts with the bracket base 810 in order to bias the ligation cover 812 toward the open, non-ligating position when the cover is in an unlocked configuration relative to the bracket base 810. This improves access to the arch wire slot 816, making insertion or removal of an arch wire easier.

In the embodiment illustrated in FIG. 12A, cam structure 826 is integrally attached to the inner surface of the ligation cover 812 in a manner so as to extend toward the bracket base 810. Further, and as is shown in particular in FIG. 12B, the cam structure 826 is received within a recess 832 between the bracket base 810 and the elongate film hinge 813 when the ligation cover 812 is in the closed position. This results in a smooth, curved outer surface 814 along both the top of the bracket and along the side.

The orthodontic bracket 800 may advantageously include a latch mechanism. The illustrated embodiment shows a latch mechanism in which increased pressure by an arch wire bearing upwardly against the ligation cover 812 results in tighter locking of the cover 812 to the bracket base 810. In the illustrated embodiment, an angled keyway 820 is provided near one end of the bracket base 810. The ligation cover 812 contains a corresponding locking tongue 822 that is insertable within the angled keyway 820.

FIG. 13A illustrates a cross sectional view of an exemplary orthodontic bracket 900 according to the basic design of FIG. 12A. The bottom surfaces of primary and secondary arch wire slots 916 and 924, respectively, are inclined relative to the bonding surface 911 of the base 910. The arch wire slots 916 and 924 are located and oriented within the bracket base 910 so as to be substantially aligned with the other slots of the bracket system once the orthodontic treatment is complete. In other words, the orientation of each slot of each bracket within the bracket system is configured so as to result in all corresponding (e.g., all primary or all secondary) arch wire slots being substantially aligned once the orthodontic treatment is complete. An orthodontic bracket having an arch wire orientation as illustrated in FIG. 13A may be particularly suited for attachment to the bicuspid.

FIG. 13B illustrates a cross sectional view of another exemplary orthodontic bracket 1000 according to the basic design of FIG. 12A. The bottom surface of the primary and secondary arch wire slots 1016 and 1024, respectively, are parallel relative to the bonding surface 1011 of the base 1010. The arch wire slots 1016 and 1024 are located and oriented within the bracket base 1010 so as to be substantially aligned with the other slots of the bracket system once the orthodontic treatment is complete. In other words, the orientation of each slot of each bracket within the bracket system is configured so as to result in all corresponding (e.g., all primary or all secondary) arch wire slots being substantially aligned once the orthodontic treatment is complete. An orthodontic bracket having an arch wire orientation as illustrated in FIG. 13B may be particularly suited for attachment to the canine.

FIG. 13C illustrates a cross sectional view of yet another exemplary orthodontic bracket 1100 according to the basic design of FIG. 12A. The bottom surface of the primary and secondary arch wire slots 1116 and 1124, respectively, are inclined relative to the bonding surface 1111 of the base 1110. The inclination of the bottom of the primary arch wire slot 1116 and secondary arch wire slot 1124 is less than the inclination of bracket 900 illustrated in FIG. 13A. The arch wire slots 1116 and 1124 are located and oriented within the bracket base 1110 so as to be substantially aligned with the other slots of the bracket system once the orthodontic treatment is complete. In other words, the orientation of each slot of each bracket within the bracket system is configured so as to result in all corresponding (e.g., all primary or all secondary) arch wire slots being substantially aligned once the orthodontic treatment is complete. An orthodontic bracket having an arch wire orientation as illustrated in FIG. 13C may be particularly suited for attachment to the incisor.

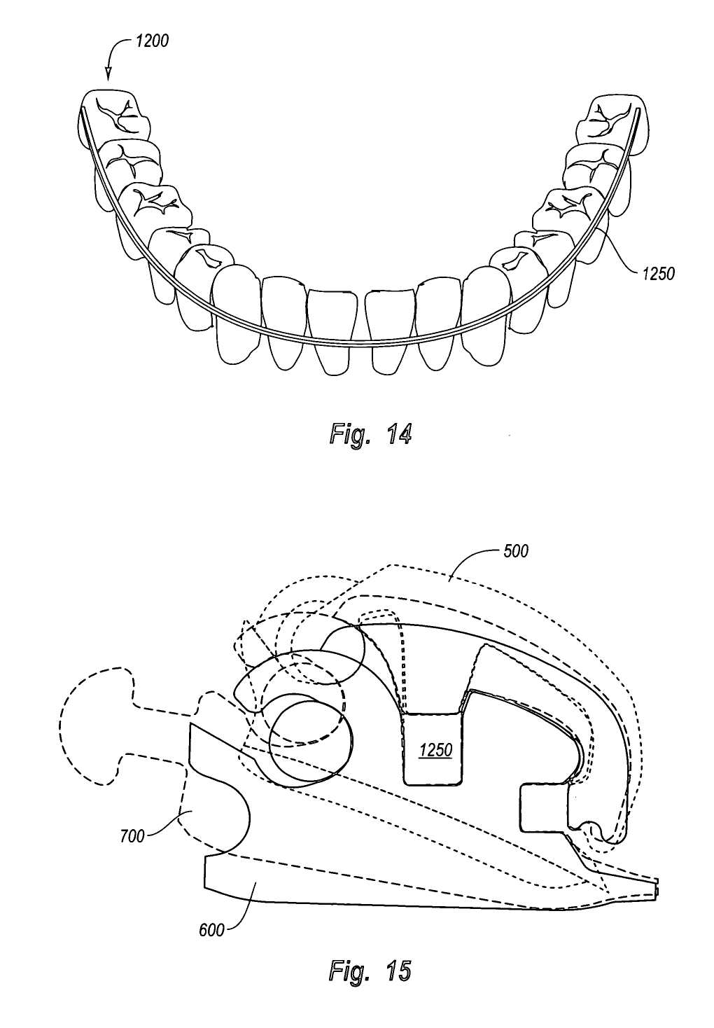

FIG. 14 illustrates a top perspective view of an upper dental arch 1200 with an arch wire 1250 once the orthodontic treatment is completed. The arch wire 1250 is engaged in a plurality of orthodontic brackets 500, 600, and 700. The arch wire 1250 is evenly and smoothly curved along the dental arch 1200, without any abrupt or irregular bends.

FIG. 15 shows exemplary orthodontic brackets 500, 600, and 700. The plurality of brackets having substantially aligned arch wire slots are viewed from the perspective of evenly curved arch wire 1250 retained within the brackets.

According to one embodiment, when in an aligned configuration, the arch wire slots of the brackets of the bracket system are aligned to within less than about 1 mm, more preferably within less than about 0.5 mm, and most preferably within less than about 0.2 mm.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of orthodontically treating a person's teeth comprising:
attaching a set of orthodontic brackets onto a person's teeth, each bracket having at least primary and secondary arch wire slots; and
attaching two or more auxiliary orthodontic devices that concurrently move teeth in a multiplicity of ways selected from:
(i) a torque spring;
(ii) at least one adjustable bite ramp;
(iii) Class II elastics; or
(iv) a single primary arch wire that is not replaced at any time with a larger arch wire, the single primary arch wire being used with a system of brackets having multiple arch wire slots that become substantially aligned when the person's teeth are aligned.

2. A method as recited in claim 1, wherein one of said auxiliary orthodontic devices comprises a torque spring, the torque spring comprising:
two curved arch wire portions that are configured to engage secondary arch wire slots of brackets attached to one or more of a patient's canines and bicuspids on either side of a patient's incisors; and
two or more bent regions between the curved arch wire portions that substantially frame two or more incisors so as to tip the substantially framed incisors in a desired direction during an orthodontic treatment.

3. A method as recited in claim 2, wherein said torque spring is formed of stainless steel, titanium, or a titanium alloy.

4. A method as recited in claim 2, wherein said torque spring is installed by:
inserting one of said curved arch wire portions into a secondary arch wire slot of a first orthodontic bracket having primary and secondary arch wire slots and the other of said curved arch wire portions into a secondary arch wire slot of a second orthodontic bracket having primary and secondary arch wire slots;
substantially framing two or more incisors with said two or more bent regions of said torque spring; and
adjusting said two or more bent regions so that they apply a force to the substantially framed incisors so as to tip the substantially framed incisors in a desired direction during orthodontic treatment.

5. A method as recited in claim 4, wherein said first and second orthodontic brackets are bonded to a person's bicuspids.

6. A method as recited in claim 5, further comprising inserting the curved arch wire portions into the secondary arch wire slots of additional orthodontic brackets bonded to a person's canines.

7. A method as recited in claim 6, further comprising inserting the curved arch wire portions into the secondary arch wire slots of additional orthodontic brackets bonded to a person's second incisors.

8. A method as recited in claim 7, wherein said orthodontic brackets are self-ligating.

9. A method as recited in claim 8, further comprising closing the cover of each self-ligating bracket so as to retain said torque spring within the secondary arch wire slot of each orthodontic bracket.

10. A method as recited in claim 1, wherein one of said auxiliary orthodontic devices comprises at least one adjustable bite ramp, the adjustable bite ramp comprising:
a tooth-attachment element sized and configured so as to be attachable to the lingual surface of a person's upper incisor; and
a ramp element hingedly or bendably adjustable relative to said tooth-attachment element, so as to provide a ramp structure at a desired angle for engagement with a lower incisor upon closing the patient's mouth in order to cause the person's lower jaw to move forward relative to the patient's upper jaw.

11. A method as recited in claim 10, said adjustable bite ramp further comprising means for locking said ramp element in a desired adjustment angle relative to said tooth-attachment element.

12. A method as recited in claim 10, wherein said adjustable bite ramp is installed by:
attaching said tooth-attachment element of a bite ramp to the lingual surface of a patient's top front incisor;
adjusting said ramp element of said bite ramp to have a desired ramp angle for engagement with the lower incisors upon closing the patient's mouth; and
locking said ramp element in the desired ramp angle.

13. A method as recited in claim 12, wherein said desired ramp angle is formed when an oblique angle exists between said ramp element and said tooth-attachment element.

14. A method as recited in claim 12, wherein said desired ramp angle is formed when an acute angle exists between said ramp element and said tooth-attachment element.

15. A method as recited in claim 12, wherein said ramp element is locked in the desired ramp angle by placing a curable composition between said tooth-attachment element and said ramp element and then allowing or causing said curable composition to harden.

16. A method as recited in claim 12, further comprising attaching a shoe onto said ramp element of said bite ramp.

17. A method as recited in claim 16, wherein said shoe includes a flat lower surface and a rounded upper surface.

18. A method as recited in claim 16, further comprising removing said shoe and replacing it with a second shoe that is smaller in size.

19. A method as recited in claim 16, further comprising removing a portion of said shoe in order to yield a smaller shoe.

20. A method as recited in claim 16, further comprising filling a space between said shoe and said tooth-attachment element of said bite ramp with a curable composition.

21. A method as recited in claim 12, further comprising attaching a plurality of said adjustable bite ramps to the surfaces of a plurality of the patient's teeth.

22. A method as recited in claim 1, wherein one of said auxiliary orthodontic devices comprises a single primary arch wire that is not replaced at any time with a larger arch wire, the single primary arch wire being used with brackets having multiple arch wire slots that become substantially aligned when the person's teeth are aligned, each bracket comprising:
a bracket base;
a primary and a secondary arch wire slot, the primary and secondary arch wire slots of each bracket being positioned relative to the bracket base so that, when the patient's teeth have become properly aligned as a result of the orthodontic treatment procedure, the primary arch wire slots of all the brackets will be substantially aligned with each other, and the secondary arch wire slots of all the brackets will be substantially aligned with each other; and
a ligation cover connected to the bracket base and selectively movable relative to the bracket base between an open, non-ligating position relative to the arch wire slots and a closed, ligating position relative to the arch wire slots.

23. A method as recited in claim 22, wherein the arch wire slots of the brackets are positioned relative to the bracket base so as to exhibit inclinations relative to the bonding surface of the bracket base between about 0° and about 25°.

24. A method as recited in claim 22, wherein when the patient's teeth have become properly aligned as a result of the orthodontic treatment procedure, the arch wire slots of all the brackets are aligned to within less than about 1 mm.

25. A method as recited in claim 22, wherein when the patient's teeth have become properly aligned as a result of the orthodontic treatment procedure, the arch wire slots of all the brackets are aligned to within less than about 0.5 mm.

26. A method as recited in claim 22, wherein when the patient's teeth have become properly aligned as a result of the orthodontic treatment procedure, the arch wire slots of all the brackets are aligned to within less than about 0.2 mm.

27. A kit for use in orthodontically treating a person's teeth comprising:
a plurality of orthodontic brackets having multiple arch wire slots;
at least two auxiliary orthodontic devices selected from a torque spring, at least one adjustable bite ramp, and a single primary arch wire.
